(19) United States
(12) Patent Application Publication
(10) Pub. No.: US 2005/0156693 A1
(43) Pub. Date: Jul. 21, 2005

(54) Quasi-coax transmission lines

(76) Inventors: Lewis R. Dove, Monument, CO (US); John F. Casey, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/762,143

(22) Filed: Jan. 20, 2004

(51) Int. Cl. H01P 3/06

(52) U.S. Cl. 333/243

(57) ABSTRACT

A plurality of conductors are deposited on a layer of dielectric that is positioned above a first ground shield. A mound of dielectric is then deposited over each conductor. Thereafter, a second ground shield is deposited over the mounds of dielectric. Quasi-coax transmission lines are thereby formed. The conductors deposited “under” the mounds of dielectric may be deposited at a greater density than conductors encapsulated “within” mounds of dielectric. Additional shielding of the conductors may be provided, for example, by coupling the first and second ground shields by means of conductive vias in the layer of dielectric.

### CROSS-REFERENCE TO RELATED APPLICATIONS

This application is related to the application of John F. Casey, et al. entitled “Methods for Making Microwave Circuits” (Docket No. 10020707-1), the application of John F. Casey, et al. entitled “Methods for Forming a Conductor on a Dielectric” (Docket No. 10030748-1), and the application of John F. Casey, et al. entitled “Methods for Depositing a Thickfilm Dielectric on a Substrate” (Docket No. 10030747-1). These applications are hereby incorporated by reference for all that they disclose.

### BACKGROUND

The patent application of Casey et al. entitled “Methods for Making Microwave Circuits”, cross-referenced supra, discloses methods for making microwave circuits in which conductors are encapsulated in generally trapezoidal mounds of dielectric. As disclosed by Casey et al., a microwave circuit may be formed by depositing a first dielectric over a ground plane, and then forming a conductor on the first dielectric. A second dielectric is then deposited over the conductor and first dielectric, thereby encapsulating the conductor between the first and second dielectrics. Finally, a ground shield layer is formed over the first and second dielectrics.

### SUMMARY OF THE INVENTION

One aspect of the invention is embodied in apparatus comprising a layer of dielectric, a plurality of conductors, a plurality of dielectric mounds, and first and second ground shields. Each of the conductors is encapsulated between the layer of dielectric and a corresponding one of the dielectric mounds. The first ground shield is positioned below the layer of dielectric, and the second ground shield is positioned above the dielectric mounds.

Another aspect of the invention is embodied in a method for forming transmission lines. The method comprises depositing a plurality of conductors on a layer of dielectric that is positioned above a first ground shield. A mound of dielectric is then deposited over each conductor. Thereafter, a second ground shield is deposited over the mounds of dielectric.

Other embodiments of the invention are also disclosed.

### BRIEF DESCRIPTION OF THE DRAWINGS

Illustrative embodiments of the invention are illustrated in the drawings, in which:

FIG. 1 illustrates a first plurality of quasi-coax transmission lines;

FIG. 2 illustrates a second plurality of quasi-coax transmission lines, capable of being formed at a greater density than the quasi-coax transmission lines shown in FIG. 1;

FIG. 3 illustrates a cross-section of the transmission lines shown in FIG. 2;

FIG. 4 illustrates a first alternative to the FIG. 3 cross-section, in which conductive vias couple the first and second ground shields;

FIG. 5 illustrates a plan view of the layer of dielectric shown in FIG. 4;

FIG. 6 illustrates a first alternate plan view of the layer of dielectric shown in FIG. 4;

FIG. 7 illustrates a second alternate plan view of the layer of dielectric shown in FIG. 4;

FIG. 8 illustrates a second alternative to the FIG. 3 cross-section, in which the dielectric mounds are spaced by a greater distance; and

FIG. 9 illustrates an exemplary method for forming the quasi-coax transmission lines of FIGS. 2-4 & 8.

### DETAILED DESCRIPTION OF THE INVENTION

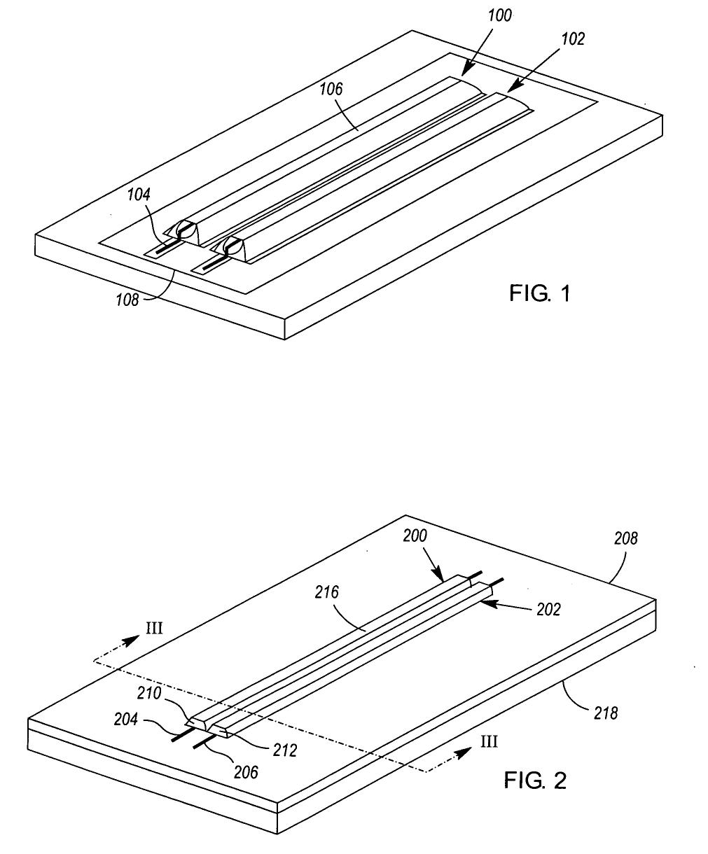

FIG. 1 illustrates a plurality of quasi-coax transmission lines 100, 102 formed in accordance with the teachings of Casey, et al.'s patent application entitled “Methods for Making Microwave Circuits”, cross-referenced supra. As defined herein, a quasi-coax transmission line 100 comprises a conductor 104, the cross-section of which is shielded 106, 108 in a non-symmetrical fashion.

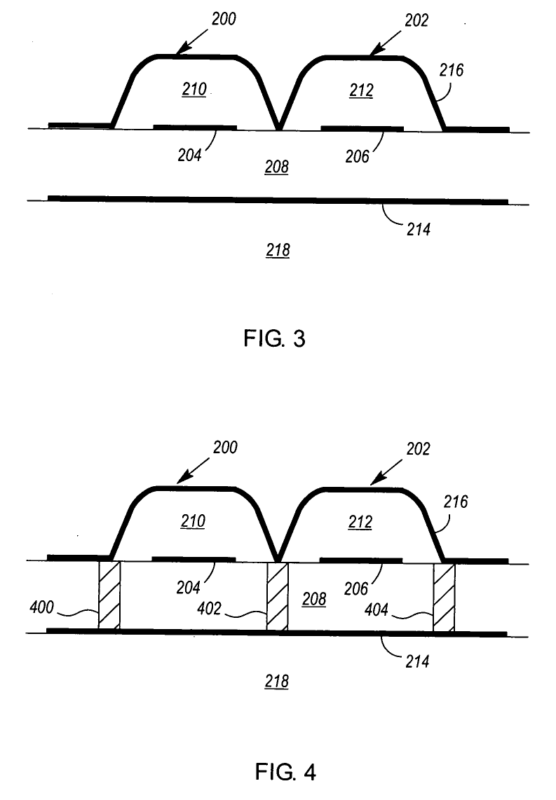

FIGS. 2 & 3 illustrate a plurality of quasi-coax transmission lines 200, 202 formed in accordance with the methods disclosed herein. FIG. 2 illustrates the transmission lines 200, 202 in perspective; and FIG. 3 illustrates the transmission lines 200, 202 in cross-section.

Referring to FIG. 3, it can be seen that a plurality of (i.e., two or more) conductors 204, 206 are encapsulated between a layer of dielectric 208 and a plurality of dielectric mounds 210, 212. That is, each of the conductors 204, 206 is encapsulated between the layer of dielectric 208 and a corresponding one of the dielectric mounds 210, 212.

The conductors 204, 206 are shielded by a first ground shield 214 positioned below the layer of dielectric 208, and a second ground shield 216 positioned above the dielectric mounds 210, 212. The first ground shield 214 may be deposited on (or may form) a substrate 218. The layer of dielectric 208 may then be deposited on the first ground shield 214. The second ground shield 216 may be deposited on the dielectric mounds 210, 212.

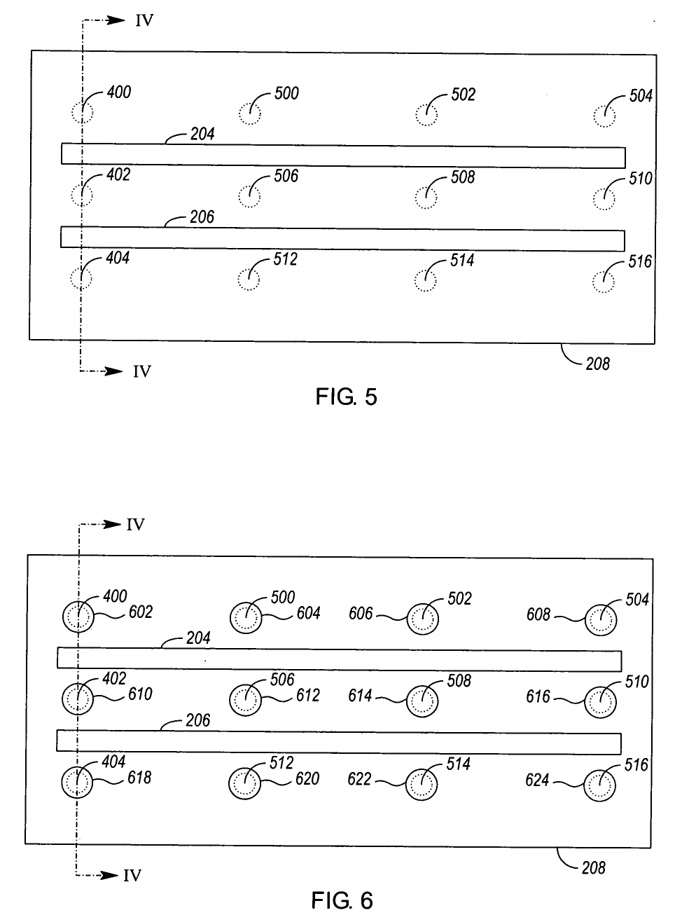

To provide better shielding for the conductors 204, 206, the FIG. 3 cross-section may be modified as shown in FIG. 4. In FIG. 4, a plurality of conductive vias 400, 402, 404 are formed in the layer of dielectric 208. The conductive vias 400-404 couple the first and second ground shields 214, 216 at points about the plurality of conductors 204, 206. FIG. 5 illustrates an exemplary plan view of the layer of dielectric 208 shown in FIG. 4, after 1) conductive vias 400-404, 500-516 have been formed therein, and 2) conductors 204, 206 have been deposited thereon.

FIG. 6 illustrates an alternate plan view of the layer of dielectric 208 shown in FIG. 4. In FIG. 6, a plurality of ground pads 602-624 are deposited on the layer of dielectric 208. The ground pads 602-624 may be placed in contact with the conductive vias 400-404, 500-516 to provide a better means for coupling the second ground shield 216 to the conductive vias 400-404, 500-516.

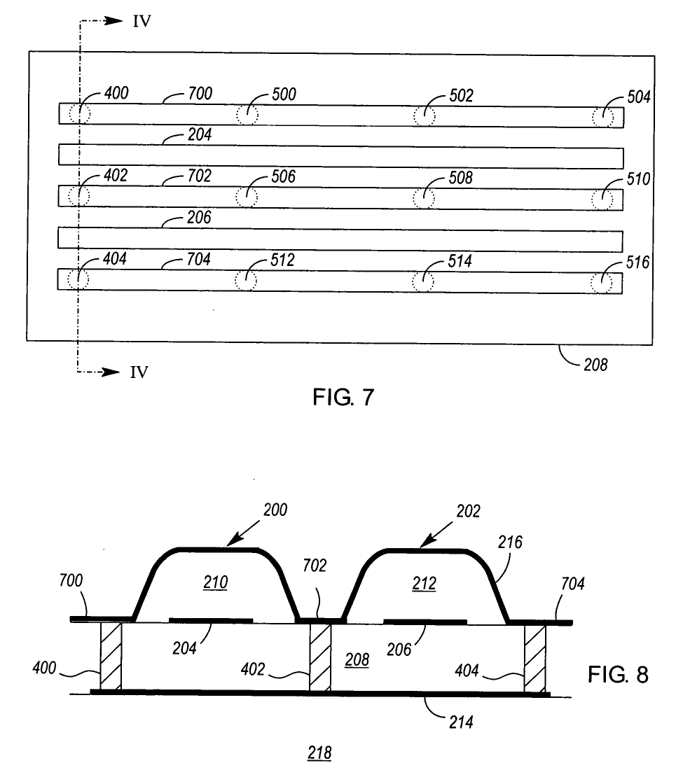

FIG. 7 illustrates another alternate plan view of the layer of dielectric 208 shown in FIG. 4. In FIG. 7, a plurality of ground traces 700, 704, 704 are deposited on the layer of dielectric 208. Similarly to the ground pads 600-604, the ground traces 700-704 may be placed in contact with the conductive vias 400-404, 500-516 to provide a better means for coupling the second ground shield 216 to the conductive vias 400-404, 500-516. Ground traces 700-704 may be advantageous to ground pads 602-624 in that they can route signal grounds along the entire length of a conductor 204, 206.

Although FIGS. 2-4 show the dielectric mounds 210, 212 being substantially adjacent one another (i.e., with the dielectric mounds 210, 212 touching, or close to touching), the dielectric mounds 210, 212 need not be this close to one another. However, when the dielectric mounds 210, 212 are separated from one another by a distance that is less than a width of one of the dielectric mounds 210, 212, the quasi-coax transmission lines 200, 202 shown in FIG. 2 may be formed at a greater density than the quasi-coax transmission lines 100, 102 shown in FIG. 1. At times, it may be advantageous to provide a small amount of space between the dielectric mounds 210, 212 (e.g., to enable the second ground shield 216 to better contact ground traces 700-704 formed on the layer of dielectric 208; see FIG. 8).

By way of example, the layer of dielectric 208 and dielectric mounds 210, 212 shown in FIGS. 2 & 3 may be glass or ceramic dielectrics. In one embodiment, the dielectrics are KQ CL-90-7858 dielectrics (thickfilm glass dielectrics) available from Heraeus Cermalloy (24 Union Hill Road, West Conshohocken, Pa., USA). The substrate 218 may be a 40 mil lapped alumina ceramic substrate with a gold ground shield 214 deposited thereon. Alternately, the substrate 218 may have a glass, ceramic, polymer, metallic or other composition. If metallic, the substrate 218 itself may serve as the first ground shield 214. The conductors 204, 206 and ground shields 214, 216 and, if provided, ground pads 602-624 and ground traces 700-704, may be deposited by printing a thickfilm conductive paste, such as DuPont® QG150, through an appropriate stencil or screen.

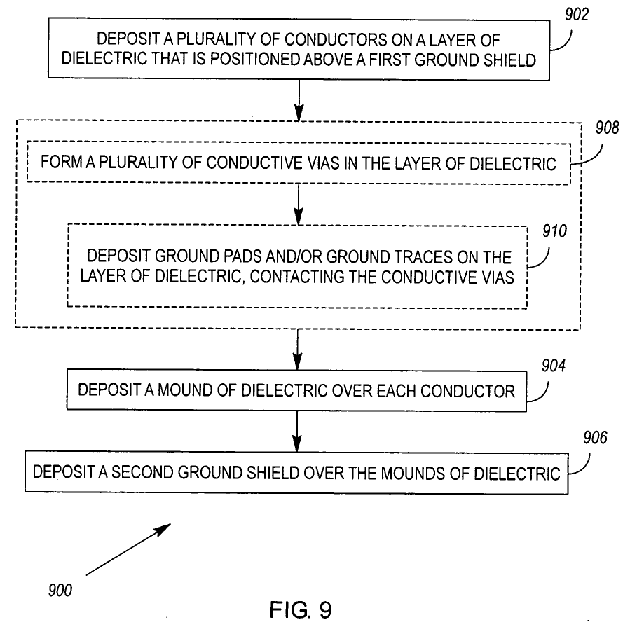

FIG. 9 illustrates an exemplary method 900 for forming the shielded transmission lines 200, 202 shown in FIGS. 2-4. To begin, a plurality of conductors 204, 206 are deposited 902 on a layer of dielectric 208 that is positioned above a first ground shield 214. A mound of dielectric 210, 212 is then deposited 904 over each conductor 204, 206. Thereafter, a second ground shield 216 is deposited 906 over the mounds of dielectric 210, 212. Optionally, a plurality of conductive vias 400-404, 500-516 may be formed 908 in the layer of dielectric 208 prior to depositing the mounds of dielectric 210, 212 on the layer (and possibly, prior to depositing the conductors 204, 206). As shown in FIG. 5, the conductive vias 400-404, 500-516 may contact the first ground shield 214, and may be formed at points about the plurality of conductors 204, 206. If the conductive vias 400-404, 500-516 are formed, the mounds of dielectric 210, 212 and second ground shield 216 are preferably deposited (e.g., sized and spaced) to ensure contact between the second ground shield 216 and the conductive vias 400-404, 500-516. Also optionally, ground pads 600-624 and/or ground traces 700-704 may be deposited 910 on the layer of dielectric 208 so as to contact the conductive vias 400-404, 500-516.

The layer of dielectric 208 and mounds of dielectric 210, 212 may be deposited, for example, by using a thickfilm printing process. Some exemplary thickfilm printing processes are disclosed in the patent application of Casey et al. entitled “Methods for Making Microwave Circuits”. In accordance with Casey et al.'s methods, each of the dielectrics may be deposited by printing multiple layers of thickfilm dielectric and then firing the layers. If desired, the dielectric layer 208 and/or dielectric mounds 210, 212 may be ground and polished to adjust their thickness. It may also be desirable to polish the dielectric layer 208 to provide a smoother surface for deposition of the conductors 204, 206.

The methods and apparatus disclosed herein are advantageous, in one respect, in that they enable the formation of quasi-coax transmission lines 200, 202 at a greater density than was previously possible.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. Apparatus, comprising:
a) a layer of dielectric;
b) a plurality of conductors;
c) a plurality of dielectric mounds, wherein each of the conductors is encapsulated between the layer of dielectric and a corresponding one of the dielectric mounds; and
d) a first ground shield positioned below the layer of dielectric, and a second ground shield positioned above the dielectric mounds.

2. The apparatus of claim 1, wherein the second ground shield is deposited on the dielectric mounds.

3. The apparatus of claim 2, further comprising a plurality of conductive vias in the layer of dielectric; the conductive vias coupling the first and second ground shields at points about the plurality of conductors.

4. The apparatus of claim 3, further comprising a plurality of ground pads deposited on the layer of dielectric; the ground pads providing a means for coupling the second ground shield to the conductive vias.

5. The apparatus of claim 2, further comprising a plurality of ground traces deposited on the layer of dielectric; the ground traces providing a means for coupling the second ground shield to the conductive vias.

6. The apparatus of claim 1, wherein at least some of the dielectric mounds are separated from one another by a distance that is less than a width of one of the dielectric mounds.

7. The apparatus of claim 1, wherein at least some of the dielectric mounds are substantially adjacent one another.

8. The apparatus of claim 1, wherein the layer of dielectric and dielectric mounds are glass dielectrics.

9. The apparatus of claim 1, wherein the layer of dielectric and dielectric mounds are KQ dielectrics.

10. The apparatus of claim 9, wherein the KQ dielectrics are KQ CL-90-7858 dielectrics.

11. The apparatus of claim 1, wherein the layer of dielectric and dielectric mounds are thickfilm dielectrics.

12. The apparatus of claim 1, further comprising a substrate; the first ground shield being deposited on the substrate, and the layer of dielectric being deposited on the first ground shield.

13. The apparatus of claim 1, wherein the conductors and second ground shield comprise DuPont® QG150 gold.

14. The apparatus of claim 1, wherein the layer of dielectric, dielectric mounds, conductors, and second ground shield comprise thickfilms.

15. A method for forming transmission lines, comprising:
a) depositing a plurality of conductors on a layer of dielectric that is positioned above a first ground shield;
b) depositing a mound of dielectric over each conductor; and
c) depositing a second ground shield over the mounds of dielectric.

16. The method of claim 15, further comprising, prior to depositing the mounds of dielectric, forming a plurality of conductive vias in the layer of dielectric, at points about the plurality of conductors; the conductive vias contacting the first ground shield; wherein the mounds of dielectric and second ground shield are deposited to ensure contact between the second ground shield and conductive vias.

17. The method of claim 16, further comprising, prior to depositing the mounds of dielectric, depositing a plurality of ground pads on the layer of dielectric; the ground pads contacting the conductive vias.

18. The method of claim 16, further comprising, prior to depositing the mounds of dielectric, depositing a plurality of ground traces on the layer of dielectric; the ground traces contacting the conductive vias.

19. The method of claim 15, wherein the layer of dielectric and mounds of dielectric are KQ dielectrics.

20. The method of claim 19, wherein each of the dielectrics is deposited by printing multiple layers of thickfilm dielectric and then firing the layers.
